(19) United States
(12) Patent Application Publication
(10) Pub. No.: US 2002/0119280 A1
(43) Pub. Date: Aug. 29, 2002

(54) Adhesive-free carpet tiles and carpet tile installations

(76) Inventor: Kenneth B. Higgins, LaGrange, GA (US)

Correspondence Address: MILLIKEN & COMPANY, 920 MILLIKEN RD, PO BOX 1926, SPARTANBURG, SC, 29304, US

(21) Appl. No.: 09/513,020

(22) Filed: Feb. 25, 2000

(51) Int. Cl. B32B 3/02; B32B 33/00

(52) U.S. Cl. 428/88; 428/95; 428/82; 428/44

(57) ABSTRACT

Cushion backed carpet tiles and carpet tile installations which can be installed without adhesives are described. The carpet tiles are manufactured according to rigid specifications in order that no corner of any of the individual tiles is 1/16″ or greater off the floor due to curl, and no corner on the tile has cup of greater than 3/16″. In this way, a substantially to entirely adhesive-free carpet tile installation can be achieved, with the installation being capable of withstanding the rigors of a variety of typical types of wear, such as rolling traffic, etc., without shifting or snowplowing over adjacent tiles.

### FIELD OF THE INVENTION

The invention generally relates to cushion backed carpet tile installations which can be installed without the use of adhesive, and the tiles used for the installations. More specifically, the invention relates to cushion backed carpet tile installations which are substantially freely laid without adhesive, yet which retain their position throughout the rigors of use, and which can withstand rolling traffic without undesirable lateral shifting.

### DESCRIPTION OF THE PRIOR ART

Carpet tile assemblies are widely used as floor coverings, as they provide a number of advantages over their broadloom counterparts. Because such tiles are provided in relatively small dimensions, e.g. generally in the form of 18 inch by 18 inch, or 36 inch by 36 inch squares, they can be used to achieve a variety of visual design effects. In addition, the lifespan of the overall floor covering can be increased, as individual tiles that become stained or damaged can be repaired of replaced without the need for replacement of the entire floor covering. Furthermore, the tiles can theoretically be rearranged during the life of the floor covering to achieve differing visual effects without replacement of the tiles themselves.

In addition, the installation of carpet tiles can in some cases be preferable to the installation of broadloom (i.e. wall-to-wall type) carpet, since the tiles can be selected and cut to conform to corners and irregularities in the floor dimension. In contrast, it can often be difficult to cut a large piece of broadloom to exact conformance with the room, since it can be difficult to integrate a number of irregularities or corners at once. Furthermore, because it is generally considered to be desirable to minimize the number of seams in a broadloom carpet installation, it is often the case that the largest piece of broadloom carpet available for use in a particular room installation is selected. This can present challenges with respect to storage and transport in addition to the obvious difficulties associated with working with a large piece of material during installation.

However, heretofore in actual practice it has not been possible to fully maximize the advantages associated with carpet tiles. Specifically, conventional methods for the installation of carpet tiles require the use of relatively strong adhesives to bond the tiles to the existing floor structure. In one common installation method, the installer coats the floor with an adhesive, allows the adhesive to set up, then secures the tiles to the floor by pressing them onto the adhesive. Typically, this involves spreading a layer of adhesive over the entire floor surface.

As will be readily apparent to those of ordinary skill in the art, this method requires that the installer sit or stand on the installed tiles, since he cannot step on the adhesive-covered floor. This can result in inadvertent slipping of the tiles as the adhesive is curing due to shifts in the installer's body weight as he reaches to install the next tile. This can in turn lead to irregularities in the appearance of the installation. In addition, the process can be awkward since the installer is forced to pull the tiles into position, and can result in a failure to achieve a tight junction between adjacent tiles. Furthermore, this method makes it possible for the carpet tiles to become damaged or soiled by the installer as they are installed. Therefore, the skill of the installer can become a critical factor in the overall quality of the carpet tile installation.

A further difficulty associated with the use of adhesively attached tiles is that the wet adhesives typically include volatile organic compounds (VOCs). To reduce any potential health risks to the installer from breathing too many fumes, it is generally considered to be important to insure that the installation environment has adequate ventilation to remove the adhesive fumes.

To overcome the problems associated with the installation of carpet tiles using wet adhesives, it has been proposed to provide the tiles with a pre-coat of adhesive, which is protected by a release sheet. While eliminating some of the problems associated with VOCs and the like, this method presents several of its own disadvantages.

For one, the release sheets, which are generally in the form of a coated paper sheet, must be disposed of following their removal from the squares. In addition, if a portion of the release sheet on a tile comes loose, the underlying surface of the tile bottom surface can lose its adhesive capabilities, meaning that the tile will not be fully secured to the floor structure about the entire dimension of the tile. This can particularly become an issue when the tiles must be cut to accommodate corners of a room or other irregularities in the room dimension. Similarly, if a portion of a release sheet comes loose from a tile prematurely, the adhesive can stick to an adjacent tile, which can result in damage to one or both of the tiles when the tiles are subsequently separated.

A further disadvantage associated with the two above-described installation methods is that they require that the flooring to which the carpet tiles are to be secured be extremely clean. Any dirt, dust or other foreign matter which is present can interfere with proper adhesive attachment of the carpet tile.

In addition, the removal of the adhesively-attached tiles presents problems in itself. In some cases, removal of the tiles can result in damage to or destruction of the tiles; this is particularly disadvantageous in view of the emerging methods for recycling and refurbishing used carpet tiles, which require that the tiles be substantially undamaged for them to be available for further processing. In addition, adhesive material that remains on the rear surface of carpet tiles can adversely affect the appearance of the refurbished tiles.

Such residual adhesive also presents problems for the flooring to which the tiles were attached, as it can be difficult as well as labor intensive to remove all of the adhesive. In fact, some property owners are hesitant to install carpet tiles, out of concern over the effects of the adhesive on the existing flooring when the tiles are removed.

Carpet tiles are generally provided in the form of relatively thin squares of carpeting material secured to a relatively rigid backing, which is designed to assist the tile in remaining flat on the floor. Because the individual tiles have relatively small perimeter dimensions, a body traveling across a carpet-tiled expanse comes into contact with a number of tile edges at the junctures of adjacent tiles. Similarly, a body rolled across a carpet-tiled expanse results in the individual tiles contacted being subjected to lateral forces, which can cause a tile to press laterally against an adjacent tile. It therefore frequently results that the lateral forces cause tiles to pop out over the edge(s) of the adjacent tiles. It is for this reason that the provision of a strong adhesive layer bonding the carpet tiles to the flooring has conventionally been seen to be so critical.

Attempts have been made to provide substitutes for the adhesive bonding of the carpet tiles to the flooring. For example, U.S. Pat. No. 4,731,275 to Andersen describes a carpet tile assembly designed to resist lateral movement. The assembly includes a layer of elastomeric material vulcanized to the carpet layer, with a plurality of protrusions and spikes being provided thereon for mating with a base layer of material, such as a felt-like fiber mat. This method therefore requires that the base layer be secured to the flooring, which would add dramatically to the cost of installation. Furthermore, while the Andersen patent purports to address the problems associated with the removal of adhesives from the flooring, the method contemplates the use of adhesives as an option for securing the base layer to the floor.

U.S. Pat. No. 4,571,353 to Gable, Jr. describes interlocking carpet tiles. Each tile has shaped side edges so that the tiles can interlock with adjacent tiles to minimize movement of the tiles in relation to each other. The Gable patent discusses the fact that free-lay tiles have a tendency to buckle, curl and warp after use. The Gable tiles are described as also having a bottom layer of thermoplastic material, with the material having indentations or other designs on its bottom surface, in order to increase the coefficient of friction with the floor. As will be readily appreciated by those of ordinary skill in the art, this construction requires additional manufacturing expense and the construction would be much more difficult to install than conventional carpet tiles due to the interlocking nature of the individual tiles.

Similarly, U.S. Pat. Nos. 4,010,301 and 4,010,302 to Anderson et al. describe carpet tiles designed to have, among other things, improved floor hugging properties. To this end, the carpet tiles described in the '301 and '302 patents include a backing layer of thermoplastic material (e.g. natural or synthetic rubber, or thermoplastic material) having a series of friction-increasing indentations or corrugations. The backing layer is illustrated as being relatively thick, and is described as being applied in the form of a relatively stiff plastisol, leveled by a doctor blade, heated and embossed by an embossing roll to form indentations on the bottom surface.

As discussed in Textiles for Residential and Commercial Interiors, by Jan Yeager, (1988), pp. 334-335, the disclosure of which is incorporated herein by reference, attempts have been made to produce “free lay” carpet tiles of the rigid carpet tile variety. However, it was recognized that such installations could only be used where heavy rolling traffic would not be expected, as such would have a “snowplow” effect, raising the edges of the modules. In an attempt to achieve a rigid free lay carpet tile, it was suggested to apply a heavy secondary backing (e.g. through the application of a heavy secondary backing such as alternate layers of heavy-gauge vinyl and glass fiber scrims) to provide increased dimensional stability. Even with this reinforcement, it was suggested that it would be desirable in many cases to glue down at least 10-20% of the carpet tiles in order to achieve satisfactory performance. Therefore, although prior products have categorized themselves as “free lay”, such terminology is understood in the art to describe products having a reduced amount of adhesive securing them to the floor, such adhesive typically being applied in a grid pattern.

Since the introduction of carpet tiles, advances have been made in their construction, including the development of carpet tiles having cushion backings. Such tiles have been found to provide superior comfort to individuals walking on, standing on, or otherwise using the installations. Because the cushion tiles do not typically have the heavy rigid reinforcement of their rigid carpet tile counterparts, it would therefore be expected that the cushion backed tiles would require even more adhesive to obtain satisfactory securement to the floor, particularly where rolling traffic would be expected. For example, carpet tile manufacturers recommend that manufacturers use at least a grid of adhesive material to secure hard-back tiles, while recommending the use of a full adhesive layer beneath cushion-backed tiles.

Commonly-assigned U.S. Pat. No. 4,522,857 describes a prior attempt to produce free-lay cushion backed carpet tiles. While representing an advance over the prior art, the carpet tiles described in that patent still required the use of a grid of adhesive to keep them in proper position during use, particularly when encountering rolling traffic.

### SUMMARY

The instant invention is directed to a cushion backed carpet tile which can be installed without the use of significant amounts of adhesive material, and preferably with no adhesive securing it to the floor.

It has been discovered by the inventor that by manufacturing the cushion backed tiles within specific physical parameters, an installation having good stability and capable of withstanding rolling traffic can be achieved using minimal to no adhesive. In particular, it has been found that by manufacturing cushion backed carpet tiles having particular amounts of cup and curl, they can be used to form entire installations which retain their position on the floor without the need for adhesive. For purposes of this invention, the term “cup” describes the amount a carpet tile comes up off of the floor (cups up) while the term “curl” describes the amount a corner curls up from the floor.

The cup and curl of the carpet tiles are desirably measured as follows:

The tile is placed in a conditioned room (i.e. at 60° F. and 20% relative humidity) for at least 4 hours. The tile is marked so that the machine direction during fabrication (typically marked with arrows on the rear of the tile) is indicated. The tile is then placed face up (i.e. pile surface up, cushion surface down) on a flat surface, with the machine direction directed forward. Starting with the closest corner on the right side, the tester measures the distance from the flat surface to the point of that corner which is highest from the flat surface. Preferably, this curl measurement is measured to the nearest 1/32^{nd}. The tile is then rotated 90°, and the process repeated for the next corner. This process is repeated until the curl has been measured for each corner.

The tile is then flipped over so that the pile surface is down on the flat surface. The distance of each corner from the flat surface is again measured to determine the degree of cup for each corner.

The carpet tiles of the instant invention are manufactured according to strict manufacturing requirements such that no corner of any tile has a cup of greater than 3/16″, and no corner has a curl of greater than 1/16″. Even more preferably, no corner of any tile has a cup of greater than 2/16″ or a curl of greater than 1/32″. In contrast, the current standards for the conventional glue-down cushion-backed product are that no corner should have a cup of greater than 7/32″ or a curl of greater than 3/32″.

The individual cushion backed carpet tiles made according to the specifications described above can be used to provide floor covering installations having a plurality of carpet tiles, which can withstand a variety of types of traffic, including rolling traffic, without the need for adhesives. Within the installation, it is therefore desirable that with none of the tiles has a corner with a cup of greater than 3/16″, and no corner has a curl of greater than 1/16″. Even more preferably, no corner of any tile in the installation has a cup of greater than 2/16″ or a curl of greater than 1/32″.

The carpet tiles of the invention can be of any desired dimension; however, the preferred shape is that of a square tile. Particularly preferred are tiles which are either 18″×18″ or 36″×36″.However, tiles having different dimensions could also be utilized within the scope of the instant invention.

The tiles can also be of any thickness desired. Tiles having a thickness of about 0.20″ to about 0.55″ are particularly preferred. Even more specifically, the cushion backing on each of the tiles desirably has a thickness of about 0.10″ to about 0.25″, and preferably about 0.20″. The carpet tiles can be of any type, including cut pile, loop pile or the like. As will be appreciated by those of ordinary skill in the art, the overall thickness of the carpet tile will vary according to the type of pile forming the upper surface of the carpet tile. The tiles can also be constructed in any conventional manner, provided the structural parameters described above can be achieved.

### DETAILED DESCRIPTION

In the following detailed description of the invention, specific preferred embodiments of the invention are described to enable a full and complete understanding of the invention. It will be recognized that it is not intended to limit the invention to the particular preferred embodiment described, and although specific terms are employed in describing the invention, such terms are used in a descriptive sense for the purpose of illustration and not for the purpose of limitation.

The instant invention is directed to a cushion backed carpet tile which can be installed and retained in position without the use of significant amounts of adhesive material, and preferably with no adhesive securing it to the floor. (For purposes of this application, the tiles have been described as being secured to a floor or surface; this is intended to encompass any surface to which the carpet tiles are secured including, but not limited to, surfaces that are to be walked upon, sat upon, ridden on, or the like.)

It has been discovered by the inventor that by manufacturing the cushion backed tiles within the specified physical parameters, an installation having good stability and capable of withstanding rolling traffic can be achieved using minimal to no adhesive. In particular, it has been found that by manufacturing cushion backed carpet tiles having the specified amounts of cup and curl, they can be used to form entire installations which retain their position on the floor with little to no adhesive.

The phenomenon enabling the unique performance of the carpet tiles of the invention is not readily understood by the inventors, since it would appear that the lateral forces experienced by a cushion backed carpet tile in response to a rolling force would be greater than those experienced with a regular rigid back-type carpet tile, thereby suggesting that the cushion product would provide a greater amount of adhesive to retain its proper position on the floor. The instant inventor suspects that the compressibility of the carpet tiles in combination with their specific flatness parameters cooperate to distribute the load of traffic (e.g., rolling traffic) in a unique manner to positively effect the distribution of the lateral forces. As a result, the tiles do not tend to snowplow over each other in the manner of conventional carpet tiles when subjected to rolling traffic and the like.

The carpet tiles of the instant invention are manufactured according to strict manufacturing requirements such that no corner of any tile has a cup of greater than 3/16″, and no corner has a curl of greater than 1/16″. Even more preferably, no corner of any tile has a cup of greater than 2/16″ or a curl of greater than 1/32″.

The individual cushion backed carpet tiles made according to the specifications described above can be used to provide floor covering installations having a plurality of carpet tiles, with none of the plurality of tiles having a cup of greater than 3/16″, and no corner having a curl of greater than 1/16″. Even more preferably, no corner of any tile in the plurality forming the adhesive-free portion of the installation has a cup of greater than 2/16″ or a curl of greater than 1/32″.

The carpet tiles of the invention can be of any desired dimension; however, the preferred shape is that of a square tile. Particularly preferred are tiles which are either 18″×18″ or 36″×36″. However, tiles having different dimensions could also be utilized within the scope of the instant invention.

The tiles can also be of any thickness desired. Tiles having a thickness of about 0.20″ to about 0.55″ are particularly preferred. Even more specifically, the cushion backing on the tiles desirably has a thickness of about 0.10″ to about 0.25″, and a compression of about half its original thickness under normal foot load of approximately 150 pounds.

The carpet tiles can be of any type and preferably include a textile surface with a foam layer functionally secured beneath the textile surface. For example, the foam layer may be secured directly to the textile surface, or may be secured by way of one or more intermediate layers. As noted above, the foam layer is desirably compressible so as to provide a level of cushioning when an individual travels across the textile surface such as walking across the floor covering. In a preferred form of the invention, the cushion layer is formed from a material having a density of about 8 lbs per cubic foot to about 22 pounds per cubic foot. In a particularly preferred form of the invention, the material has a density of about 16 pounds per cubic foot. The cushion can be formed from any material which provides the requisite performance properties; polyurethane has been found to perform particularly well in this application.

The textile surface can be of any variety desired, including but not limited to a coated woven, knit or nonwoven fabric, a cut pile, loop pile, bonded, tufted surface, or the like. As will be appreciated by those of ordinary skill in the art, the overall thickness of the carpet tile will be varied according to the type of pile forming the upper surface of the carpet tile. The tiles can also be constructed in any conventional manner, provided the structural parameters described above can be achieved.

The installation of the tiles will desirably be performed as follows, although other methods can be utilized within the scope of the invention. In order to provide an equal number of tiles around the perimeter of the room, the installer will typically measure the room to determine the center point. A minimal number of tiles (generally four tiles) will desirably be aligned at the room center point, and temporarily secured into place by way of double stick tape. Since no adhesive is then required for the carpet tiles, the tiles can be pushed into place about the center tiles, progressing outwardly until the entire flooring region which is to be covered is properly overlaid with tiles. As will be appreciated by those of ordinary skill in the art, this enables tiles to be pushed into place as well as pulled into place. Therefore, an installer can position himself in the most efficient position for installing the tiles rather than being forced to sit on the already installed tiles as was the case with most adhesive installation methods. If desired, the double stick tape can then be removed from beneath the four centered tiles to provide an entirely adhesive-free installation.

In the specification there has been set forth a preferred embodiment of the invention, and although specific terms are employed, they are used in a generic and descriptive sense only and not for purpose of limitation, the scope of the invention being defined in the claims.

I claim:

1. A carpet tile suitable for use in adhesive-free installations, said carpet tile comprising:
an upper textile surface; and
a layer of foam material, said layer of foam material being functionally secured beneath said upper pile surface, and said layer of foam material being adapted to provide cushioning to a force pressing against said upper textile surface, said carpet tile having a plurality of corners wherein each of said corners has a cup of about 3/16″ or less and a curl of about 1/16″ or less.

2. A carpet tile according to claim 1, wherein each of said corners has a cup of about 2/16″ or less and a curl of about 1/32″ or less.

3. A free lay cushion backed carpet tile installation comprising:
a plurality of carpet tiles positioned in an abutting relationship relative to each other and substantially freely overlying a predetermined surface, wherein each of said carpet tiles has a plurality of corners, with said corners having a cup of about 3/16″ or less and a curl of about 1/16″ or less.

4. A free lay cushion backed carpet tile installation according to claim 3, wherein each of said corners has a cup of about 2/16″ or less and a curl of about 1/16″ or less.
